(19) United States
(12) Patent Application Publication
(10) Pub. No.: US 2009/0252829 A1
(43) Pub. Date: Oct. 8, 2009

(54) BREWING VINEGAR AND IT'S MANUFACTURING METHOD

(75) Inventors: Yoshifumi TAMURA, Hokkaido (JP); Shuji Yoshikawa, Hokkaido (JP); Nobuaki Ito, Hokkaido (JP); Yukinobu Tatsuta, Hokkaido (JP); Nobutaka Kasai, Hokkaido (JP); Kyoei Horiuchi, Hokkaido (JP)

Correspondence Address: BROWDY AND NEIMARK, P.L.L.C.;624 NINTH STREET, NW, SUITE 300, WASHINGTON, DC, 20001-5303, US

(73) Assignee: Marukatsu Co., Ltd., Hokkaido (JP)

(21) Appl. No.: 12/209,766

(22) Filed: Sep. 12, 2008

(30) Foreign Application Priority Data
Apr. 4, 2008 (JP) P4104080

(51) Int. Cl. C12J 1/00

(52) U.S. Cl. 426/17; 426/634

(57) ABSTRACT

The brewing vinegar produced by zymolysis and alcohol fermentation in the bean jam particle of sloppy legumes such as adzuki bean in paraellel, and subsequently its acetic acid fermentation and its manufacturing method. By this manufacturing method the alcohol fermentation in the product by zymolysis is performed immediately, which shows the effective prevention of corruption by pest bacteria. Brewing vinegar containing abundant polyphenol is produced by the acetic acid fermentation performed sequentially.

### BACKGROUND OF THE INVENTION

1. Field of the Invention

The present invention relates to the brewing vinegar and the manufacturing method of the brewing vinegar and, more particularly, the present invention relates to the alcohol fermentation by the addition of yeast to the zymolysis products of the bean jam particles of the sloppy legumes such as the adzuki beans and subsequently acetic acid fermentation to produce the brewing vinegar.

2. Description of Related Art

The brews such as the refined sake which assumed cereals raw materials are generally produced by the alcohol fermentation of the malt sugar and glucose generated by the disintegration of the starch of cereals with malted rice.

As the sloppy legumes such as the adzuki bean contains a lot of starch compared to the cereals, such a kind of starch is difficult to be disintegrated in the zymolysis by using the yeast. Because the bean jam particles of the sloppy legumes are easily formed by the absorbing the water and subsequently heating, additionally the starch contained in the bean jam particles is surrounded by the protein and the polysaccharide such as pectin, xylan and so on.

As for this kind of starch contained in the bean jam particles, resolution reaction by the amylolysis enzyme is not caused easily. It has not been used as raw materials of alcohol fermentation such as liquor or the vinegar due to these reasons.

The sloppy legumes such as adzuki beans have lots of starch unlike legumes. Therefore it needed not to be used by fermentation seasoning regarding the taste such as miso or the soy sauce as important.

As for the bean jam particle generated by sloppy legumes, the zymolysis by the malted rice was not impossible, but it took lots of time and was remarkably impossible practically. That is why it is not used as raw materials of the liquor and the miso.

### SUMMARY OF THE INVENTION

The present invention implements a reasonable method to change into sugar and the amino acid in which fermentation could proceed by disintegrating a bean jam particle with various enzymes such as a proteolytic enzyme, a starch catabolic enzyme, a pectin catabolic enzyme, a xylan catabolic enzyme.

As for the sugar and the amino acid generated by this method, the pollution by various germs coming from raw materials may go. Because Bacillus bacteria stick to sloppy legumes, and the live germ is usually perished by heating, but the spore with the live germ which is not perished by heating remains, and it germinates at the time of the zymolysis of the sugar and amino acid, and this grows it, and the pollution of various germs due to the Bacillus is worse.

The present invention implements a method to prevent the outbreak of various germs, the corruption by Bacillus bacteria in particular with the generation of the quantity of alcohol which was necessary for acetic acid fermentation by carrying out fermentation by the yeast in parallel at the same time to understand a bean jam particle for an enzyme.

The malt sugar and glucose generated by zymolysis are immediately changed into alcohol by performing alcohol fermentation by the yeast at the same time. Because malt sugar and glucose are used immediately in this way, enzyme reaction goes immediately and, as a result, will raise the effect of the enzyme.

The alcohol fermentation liquid of sloppy legumes provided by such a method was found to include various ingredients. That is why, in the acetic acid fermentation performed continuously, the growth of the acetic acid bacteria that it is easy to be disintegrated by polyphenol goes smoothly, and good acetic acid fermentation proceeds.

The adzuki bean vinegar produced by such a method as described above includes a lot of crude protein, potassium, magnesium than the normal vinegar. And a lot of polyphenol coming from an adzuki bean is included and has the high antioxidation characteristics with it.

The quantity of polyphenol contained in adzuki bean vinegar is nearly equal with black vinegar of the Mizkan Nakano Company that is a major vinegar maker in Japan. It contains polyphenol much more than the normal black vinegar maker, and, as a matter of course, the antioxidation characteristics is superior with it, too.

Vinegar is provided by taking the processing method how is similar to an adzuki bean in the case of kidney bean legumes. A lot of potassium and magnesium coming from these raw material beans is included in vinegar generated by the kidney bean legumes such as tebou and kintoki.

The vinegar generated from kidney bean legumes contains approximately equal to that of azuki bean. The antioxidation characteristics of kidney bean legumes is inferior to an azuki bean slightly, but they are stronger than that of the normal black vinegar in Kagoshima prefecture in Japan. These antioxidation characteristics is higher than that of the commercial vinegar markedly.

### BRIEF DESCRIPTION OF THE DRAWINGS

FIG. 1 is flow chart outlining the manufacturing methods of brewing vinegars which assumed sloppy legumes raw materials such as adzuki beans.

FIG. 2 is a bar graph showing the quantities of polyphenol in sloppy bean vinegar and various commercial vinegars.

FIG. 3 is a line graph showing the consumption of DPPH for the quantity of addition of various brewing vinegar to the DPPH solution.

FIG. 4 is a table showing the general ingredients of the Adzuki bean brewing vinegar vs. commercial vinegars in Japan.

FIG. 5 is a bar graph showing the increasing tendency of sugar content for the elapsed time after the enzyme.

### BRIEF DESCRIPTION OF THE PREFERRED EMBODIMENTS

The following description is provided to enable any person skilled in the art to make and use the invention and sets forth the best modes contemplated by the inventor of carrying out this invention. The adzuki bean which is the one of the sloppy legumes is explained as an example, but the sloppy legumes such as kintoki, tebou, and so on are also used as raw materials.

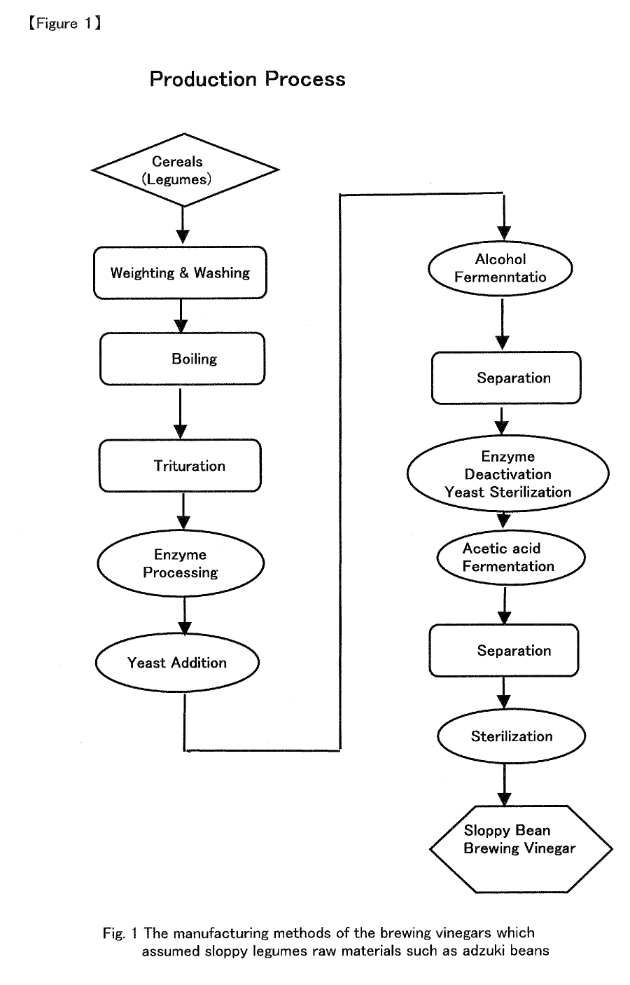

FIG. 1 shows the manufacturing method to prepare the brewing vinegar from the sloppy legume such as the adzuki bean, tebou, kintoki and so on.

The dry adzuki bean is boiled in water. It is also possible that the dry adzuki bean swelled with water is boiled according to its dry condition. The quantity of additive water and the time to boil are decided depending on the dry situation of the adzuki bean.

The mixture of the boiled adzuki bean and the broth stewed like statement above is triturated to promote zymolysis effectively. The device to triturate its mixture is possible to be used even the device of any kind of method if an adzuki bean is shattered.

The enzyme is added to the mixture of the triturated adzuki bean and broth interpreted above and the zymolysis reaction is pushed forward in a state by the constant temperature. As for the temperature, 50 degrees Celsius, the discrimination time is two or three hours when they show an example of the zymolysis reaction condition to give glucose and malt sugar.

In this case the sugar content in the product by the zymolysis reaction is confirmed to be 10% which supports Blix value and the most suitable reaction temperature of the fermentation by the yeast is decided to be 25° C. The fermentation to be based on yeast with zymolysis reaction by adding yeast immediately in the solution of the zymolysis reaction is allowed to be done. The propagation of various germs by performing these reactions with harmony could be prevented very effectively.

The alcohol fermentation by yeast should be done in parallel with the production of malt sugar and glucose by enzyme reaction. In this case the reaction is allowed to be done for 72 hours at 20 degrees Celsius to generate the solution containing the alcohol more than 6%.

A solid share from provided solution should be filtered by using an appropriate filter device. If it is the device which can remove a solid share, any kind of device could be used.

The deactivation of the enzyme function and sterilization disposal of yeast should be performed by heating the top liquid removed a solid share at about 85 degrees Celsius for 10-20 minutes. After heat-treating it, it cools off immediately. This cooling process is better performance, however, it is not always necessary.

Acetic acid fermentation is carried out at 30 degrees Celsius after adding an acetic acid bacteria as seed vinegar to the solution provided by the method described above.

After finishing of acetic acid fermentation, the solution is filtered to remove a solid share, aged, and sterilized to generate the brewing vinegar.

The present invention to produce the brewing vinegar from the sloppy legumes is completed according to the procedure as interpreted above.

### DETAILED DESCRIPTION OF THE INVENTION

In the present invention the adzuki bean is used as the sloppy legume, and the 0.4% aqueous serlosine (xylanase prepared by HBI Enzymes Company) and 0.4% aqueous cokulase M (glucoamylase prepared by Mitsubishi Chemical Foods Company) are used as the enzyme. The enzyme to be used in the present invention is not restricted within this kind of enzyme.

Any kind of yeast could be used if it is used for alcohol fermentation and it is also possible to use the yeast for the milk sugar fermentation. In the present invention the kyoukai 701 (Japanese brewing association) is used as the yeast.

Any kind of acetic acid bacteria could be used if it is used for preparing the brewing vinegar. In the present invention the IFO 14814 is used as the acetic acid bacteria.

The washed adzuki bean is boiled and it is disintegrated by masscolloider at the temperature in the boiling condition.

The solution of disintegrated adzuki bean is cooled down to 50 degrees Celsius which is optimum temperature for enzyme activity. The enzyme is added to this solution and stirred for 2 hours to produce the sugar content, that is, the Brix value is more than 18%. By the way the condition before adding an enzyme is that the Brix value is 8.0% and the content of water is 77.0%.

After the zymolysis reaction the solution is cooled down to 25 degrees Celsius and the yeast is added to this solution. The alcohol fermentation of this solution is carried out at 20 degrees Celsius for 4 days to produce the solution having the alcohol content about 7.0%.

A solid share from provided solution is filtered off to give the homogeneous solution by using the press filter.

The alcohol fermentation solution of this adzuki bean is heated at 85 degrees Celsius for 15 minutes in order to deactivate the enzyme and sterilize the yeast remained in this homogeneous solution.

The acetic acid bacteria is added to the homogeneous solution as obtained above, which is kept quietly at 30 degrees Celsius for several weeks in order to ferment. The fermentation time is dependent on the quantity of the alcohol contained in the reaction system.

After finishing of the acetic acid fermentation the solution is filtered off to give the other solution, which is aged. After aging reaction the acetic acid bacteria is sterilized to produce the adzuki bean vinegar contained about 5% acetic acid.

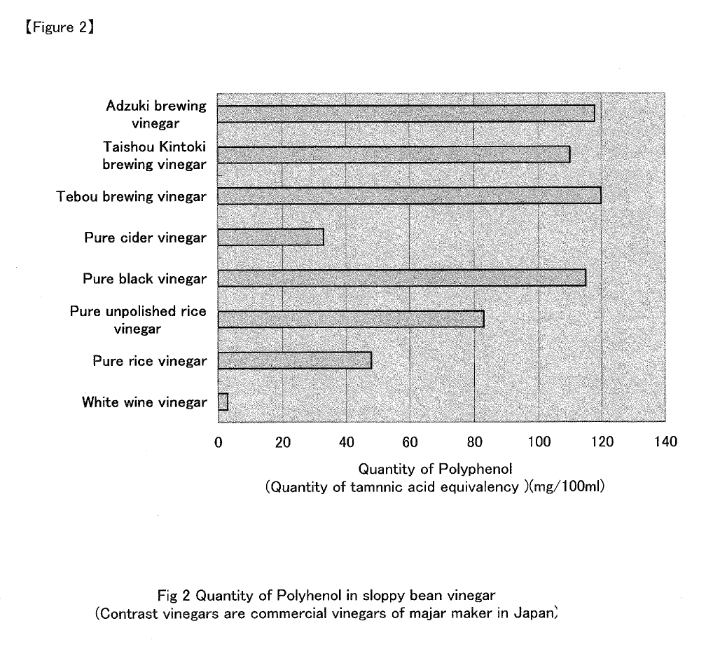

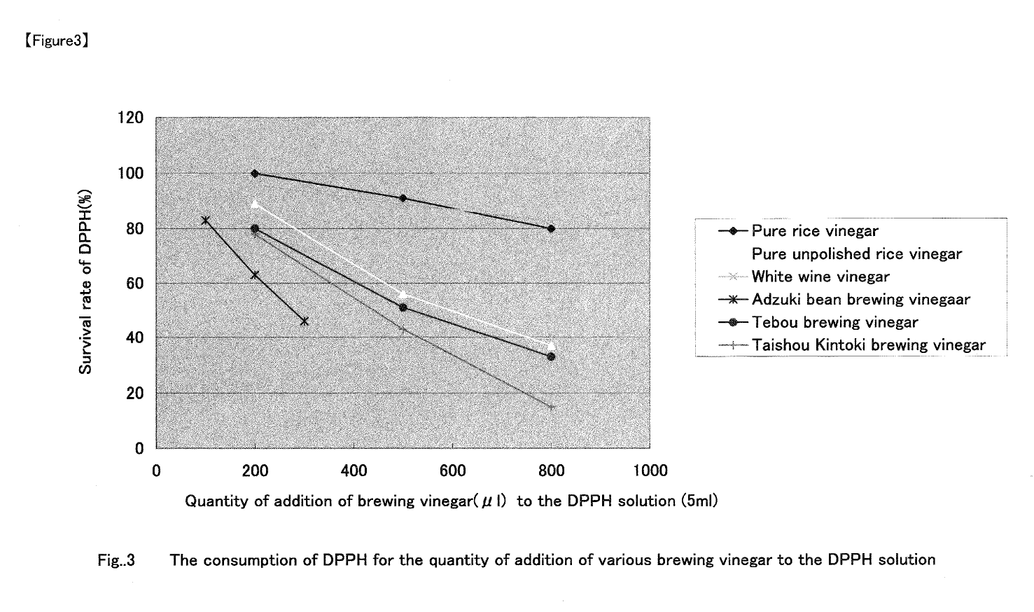

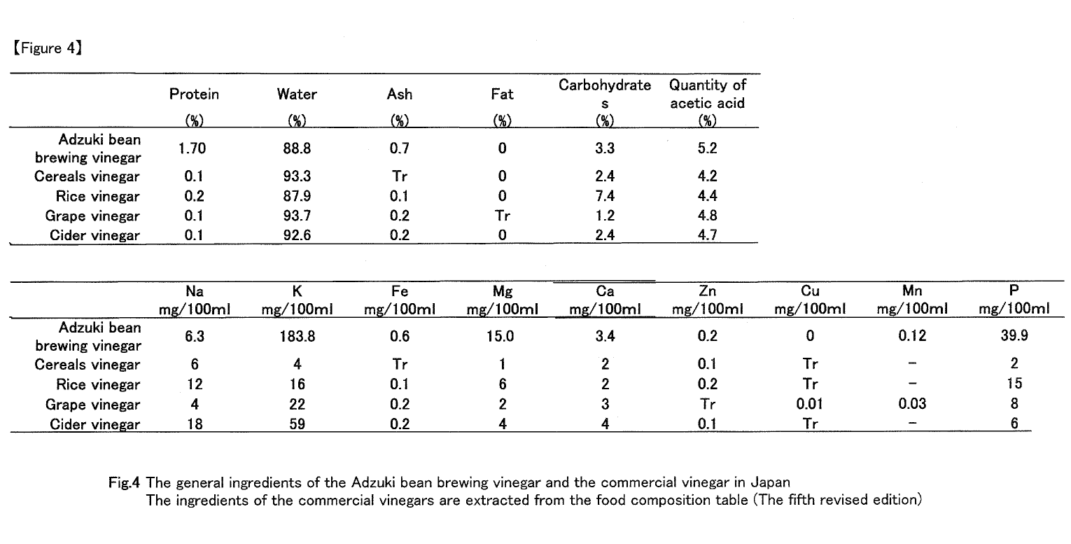

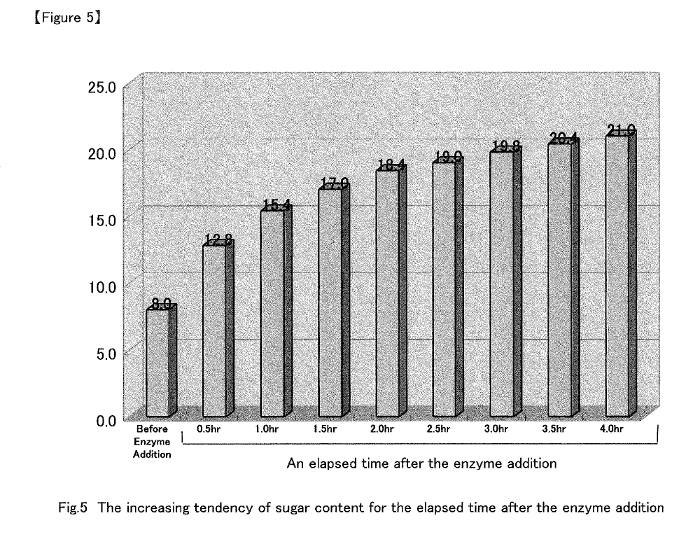

The adzuki bean vinegar obtained by the procedure as interpreted above contains polyphenol more than the commercial vinegar as shown in FIG. 2 and still it contains the strong characteristics of the antioxidant as shown in FIG. 3. Additionally, this vinegar contains the high contents of potassium ion and magnesium ion as shown in FIG. 4. The increasing tendency of sugar content is shown in FIG. 5.

The brewing vinegars prepared from the sloppy legume such as tebou and kintoki beans contain polyphenol more than the commercial vinegar as shown in FIG. 2 and still they have the stronger characteristics of antioxidant than that of the commercial vinegar as shown in FIG. 3. They contain the high content of potassium ion and magnesium ion, too.

The brewing vinegar prepared from the sloppy legume such as tebou and kintoki beans has the high viscosity different from that of the adzuki bean, which is quite different characteristic from those of other brewing vinegars. In the case of brewing vinegar having the high viscosity their distinctive stimulation is reduced.

When they are applied for the vinegared food, the surface of the food becomes smooth compared with the normal vinegar. So, the vinegared food goes down the person's throat smoothly. This kind of vinegared food is useful for the patient who is difficult to eat the food.

What is claimed is:

1. The brewing vinegar produced by zymolysis and alcohol fermentation in the bean jam particle of sloppy legumes in parallel, and subsequently its acetic acid fermentation.

2. The manufacturing method of the brewing vinegar produced by zymolysis and alcohol fermentation in the bean jam particle of the sloppy legumes in parallel, and subsequently its acetic acid fermentation.

3. The brewing vinegar of claim 1 wherein the sloppy legume is Vigna.

4. The brewing vinegar of claim 1 wherein the sloppy legume is Phaseolus.

5. The brewing vinegar of claim 1 wherein the sloppy legume is Pisum.

6. The brewing vinegar of claim 1 wherein the sloppy legume is adzuki bean.

7. The brewing vinegar of claim 1 wherein the sloppy legume is Taishou-kintoki.

8. The brewing vinegar of claim 1 wherein the sloppy legume is Yuki-tebou.

9. The brewing vinegar of claim 1 wherein the sloppy legume is Nakachou.

10. The manufacturing method of the brewing vinegar of claim 2 wherein the sloppy legume is Vigna.

11. The manufacturing method of the brewing vinegar of claim 2 wherein the sloppy legume is Phaseolus.

12. The manufacturing method of the brewing method of claim 2 wherein the sloppy legume is Pisum.

13. The manufacturing method of the brewing vinegar of claim 2 wherein the sloppy legume is adzuki bean.

14. The manufacturing method of the brewing vinegar of claim 2 wherein the sloppy legume is Taishou-kintoki.

15. The manufacturing method of the brewing vinegar of claim 2 wherein the sloppy legume is Yuki-tebou.

16. The manufacturing method of the brewing vinegar of claim 2 wherein the sloppy legume is Nakachou.

17. The brewing vinegar of claim 1 wherein the enzyme agents to use for zymolysis is protease.

18. The brewing vinegar of claim 1 wherein the enzyme agents to use for zymolysis is amylase.

19. The brewing vinegar of claim 1 wherein the enzyme agents to use for zymolysis is pectinase.

20. The brewing vinegar of claim 1 wherein the enzyme agents to use for zymolysis is xylanase.

21. The manufacturing method of the brewing vinegar of claim 2 wherein the enzyme agents to use for zymolysis is protease.

22. The manufacturing method of the brewing vinegar of claim 2 wherein the enzyme agents to use for zymolysis is amylase.

23. The manufacturing method of the brewing vinegar of claim 2 wherein the enzyme agents to use for zymolysis is pecinase.

24. The manufacturing method of the brewing vinegar of claim 2 wherein the enzyme agents to use for zymolysis is xylanase.

25. The brewing vinegar of claim 1 wherein the jam particle of sloppy legumes cooked is crushed into pieces.

26. The manufacturing method of the brewing vinegar of claim 2 wherein the jam particle of sloppy legumes cooked is crushed into pieces.
